(19) United States
(12) Patent Application Publication
(10) Pub. No.: US 2002/0005836 A1
(43) Pub. Date: Jan. 17, 2002

(54) Image signal transmitting apparatus

(76) Inventor: Po-Sheng Shih, Hsinchu (TW)

Correspondence Address: RABIN & CHAMPAGNE, PC, 1101 14TH STREET, NW, SUITE 500, WASHINGTON, DC, 20005, US

(21) Appl. No.: 09/855,761

(22) Filed: May 16, 2001

(30) Foreign Application Priority Data
May 17, 2000 (TW) 89109494

(51) Int. Cl. G09G 5/00

(52) U.S. Cl. 345/169

(57) ABSTRACT

An image signal transmitting apparatus is provided. The image signal transmitting apparatus includes: a function selection panel with a multiple keypad; a receiving unit which receives image signals via a transmission interface; a controller which controls the transmission of the image signals; and a transmitting unit, linked to the controller, for transmitting the image signals. A user first inputs the image signals which is taken by an image acquiring system or stored in a storage system to the image signal transmitting apparatus. Then, the image signal transmitting apparatus is connected to a communication link and transmits the image signals via such a communication link as a network or a wireless communication system. Then, an image signal receiving center receives the image signals for central processing, and makes pictures according to the image signals. It has the advantages of being simple, convenient, and economic.

### BACKGROUND OF THE INVENTION

This application incorporates by reference Taiwanese application Ser. No. 89109494, filed on May 17, 2000.

### FIELD OF THE INVENTION

The invention relates in general to an image signal transmitting apparatus, and more particularly to an image signal transmitting apparatus for transmitting image signals to an image signal receiving center for central processing and outputting.

### DESCRIPTION OF THE RELATED ART

Along with the advances in modern information technology, the use of networks has become a part of everyday life. Using a personal computer, anyone can now send information or data to a remote location easily and rapidly. As a consequence, the business transaction behavior is changing from conventional shopping, such as going to the shop personally, to Internet shopping. Sitting in front of a computer, the consumers can now easily select and buy their favorite products.

Naturally, the convenience of network systems coupled with the digitization of signals has seen its wide application to daily commercial behavior. Take the photo developing technology for instance. Conventionally, after the film is developed and pictures printed, the negative image on the film is fixed and unalterable. This disadvantage, coupled with the inability of developed film to be recycled, led technicians to apply digital software in photographic technology to produce the Digital Still Camera (DSC), which is commonly seen nowadays. The DSC stores images as digital data in memory and not only allows the memory to be accessed and used repeatedly, it can also be modified through computer processing. Furthermore, the total amount of time required to obtain a hard copy of the image on paper can be greatly reduced.

Ordinary digital still cameras have digital signals printed out using a photo printer. However, this costs more than 30 cents including consumable materials such as ribbons for each photo. As compared to the developing and printing cost of 10 to 13 cents per photo using a conventional camera, it is indeed too expensive. Besides, the quality of picture produced using an ordinary digital camera is inferior to that produced using conventional photo developing. Therefore, an image processing apparatus, which can process both conventional films as well as images taken with a digital still camera, came into the market. With this image processing apparatus, conventional negative image on films are developed and made into real photos by the use of optical projection techniques. As for the image signals taken from a digital still camera, they are inputted into the above-mentioned image processing apparatus via a Personal Computer Memory Card International Association (PCMCIA) Card or using an interface such as Universal Serial Bus (USB) interface, and then transformed into optical image signals. By using optical projection techniques, the optical image signals are then developed, resulting in real photos. In this way, the cost can be reduced to be equivalent to or even lower than that using the conventional developing method. As well, the picture quality of photos produced in this way is better than that produced using a photo printer. The above-mentioned image processing apparatus can be incorporated with back-end application systems of various kinds to provide various image application services. For instance, the consumer can request that the inputted images be shown on the surface of a cake using edible pigments. Such a cake may have special significance to the consumer. However, such an image processing apparatus may cost up to hundreds of thousand dollars, which is beyond the reach of ordinary photo studios and households. As for ordinary people, they are neither able to afford it, nor are they willing to spend the subsequent maintenance costs. The cost needed will be reduced, if image signals can be transmitted, either via a network or wireless communication system, to image signal receiving centers installed in a metropolitan area or a service center equipped with the image processing apparatus.

Similarly, there are beautiful patterns on hats, cups or compatible discs that are being sold in the market. However, the products and patterns that a factory manufactures may not be able to satisfy consumers' needs for the expression of specific personal style. It would cost a lot if a consumer were to produce these patterns himself or herself. Therefore, using a network or a wireless communication system to transmit image signals using modem technology, manufacture cost will be effectively reduced and the consumer's needs satisfied.

### SUMMARY OF THE INVENTION

It is therefore an object of the invention to provide an image signal transmitting apparatus. Using a simple transmitting apparatus, image signals can be transmitted to the above-mentioned image signal receiving centers or service bases in a metropolitan area to be outputted after central processing. In addition, the image to be processed can be conveniently transmitted to the above-mentioned image signal receiving centers or service bases without using a computer. In this way, the image picturing costs can be effectively reduced, the image output quality improved, and various applications of personal style images made available.

According to the object of the invention, an image signal transmitting apparatus is provided. The image signal transmitting apparatus is used for transmitting image signals stored in an image acquiring system or a storage system to an image signal receiving center for processing the image signals. In addition, the signal transmitting apparatus includes a function selection panel, a receiving unit, a controller, and a transmitting unit. The function selection panel including a multiple keypad is used to enter transmission signals. The receiving unit includes a transmission interface, wherein the receiving unit receives the image signals stored in the image acquiring system or storage system through the transmission interface. The controller is then for receiving the image signals received through the transmission interface and the transmission signals, and for controlling the sending of the image signals. The transmitting unit is coupled to the controller, for sending the image signals to the image receiving center in a remote location according to the transmission signals. Besides, the image signal receiving center can be equipped with an image processing apparatus which can process both conventional films as well as digital images. In this way, the image signal receiving center is used for processing the image signals so as to produce photos by developing the images using optical projection techniques. Thus, since the image signals are transmitted by means of a simple configuration without using a computer, and can be developed using cost-effective techniques, the total cost is reduced.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1A is the top view of the image signal transmitting apparatus according to a preferred embodiment of the invention;

FIG. 1B is a structural block diagram of the image signal transmitting apparatus in FIG. 1A;

FIG. 2 is a flowchart of the image signal transmitting method according to a preferred embodiment of the invention; and

FIG. 3 is a block diagram of the network system used in the image signal transmitting method according to the invention.

### DESCRIPTION OF THE PREFERRED EMBODIMENT

The features of the embodiment of the invention will be explained using the following examples of photo developing technology.

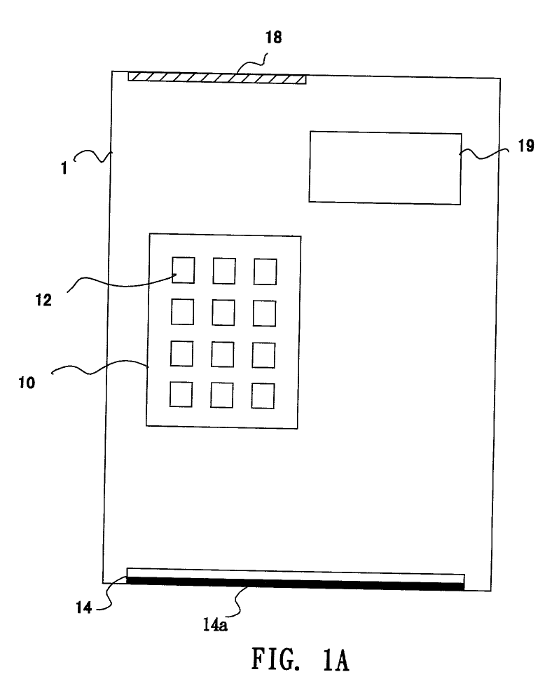

Referring to FIG. 1A and FIG. 1B, a top view and a structural block diagram of the image signal transmitting apparatus according to a preferred embodiment of the invention are shown respectively. The image signal transmitting apparatus 1 includes a function selection panel 10 with a multiple keypad used for a user to enter signals or access codes. For instance, the user can enter numbers 0 to 9 and letters A to Z into the image signal transmitting apparatus 1. The image signal transmitting apparatus is further equipped with a receiving unit 14, which receives the image signals to be processed using a transmission interface 14a. A controller 16 to receive the input from the receiving unit 14 and keypad 12, and then have the image signals outputted is further utilized. As an example, the controller 16 can be a commonly seen microprocessor.

The image signal transmitting apparatus, using a transmitting unit 18, transmits the image signals outputted from the controller 16 by means of a communication link, such as the Internet, a Local Area Network (LAN), or a WCS. In the instance of using the WCS as a way of transmitting the image signals, the user's demands of time-saving and high efficiency can be satisfied since data transmission speed supported by the third generation mobile communication system can be as fast as 2M bits/sec.

The transmission interface 14a is used to connect to an image acquiring system or a storage system. The transmission interface 14a can be a device interface such as a USB interface or an Integrated Device Electronics (IDE) Interface. By means of such a USB interface or by inserting another PCMCIA card, the receiving unit 14 can receive the image signals of the digital still camera 11 along with a USB port. In addition, the receiving unit 14 can be connected to a scanner 13 to receive image signals of a scanned image. When the transmission interface 14a is an IDE interface, it can receive the image data stored in a CD-ROM by using a CD-ROM drive 15a linked to it; or read the image data stored in a hard disk drive 15b when linked to it.

The receiving unit 14 can be further linked to a floppy disk drive 17 to retrieve data from a floppy disk. The image signal transmitting apparatus 1 can further include a display panel 19, being linked to the controller 16, to display the contents inputted through the keypad 12 as well as the status of the image signal transmission or the communication link (e.g. Internet) connection. The above-mentioned display panel 19 can be the display panel such as one used in an ordinary fax machine or mobile phone for instance.

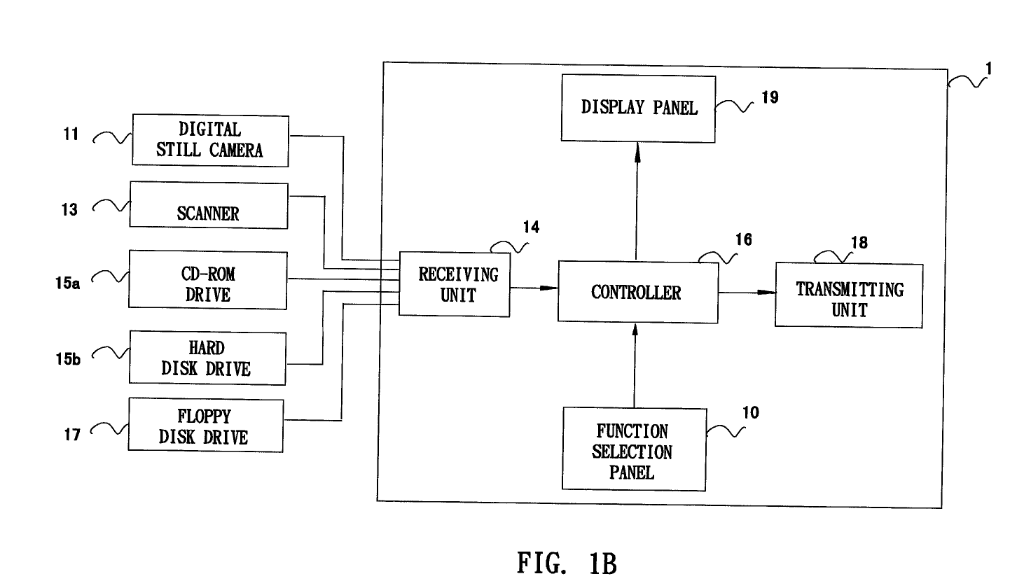

Referring to FIG. 2, a flowchart of the image signal transmitting method according to the image signal transmitting apparatus in FIG. 1 is shown. First, the user inputs image signals into the image signal transmitting apparatus 1 as shown in step 21, where the image signals are provided through a device such as the digital still camera 11, scanner 13, CD-ROM drive 15a, hard disk drive 15b, or floppy disk drive 17. Next, in step 23, connection to a network is established. If using the Internet, the keypad 12 is used to input the user's network address, such as Internet Protocol (IP) address, or email address, as well as the address of the receiving end, such as a website. If using the WCS, the keypad 12 is used to input the communication address (number) of the receiving end. Afterwards, the image signal receiving center receives the image signals for central processing and makes photos from those image signals as shown in step 25. Finally, the photos produced are sent to users as shown in step 27. Generally speaking, there are only a limited numbers of image signal receiving centers near the location of the user. In order to facilitate an easy and convenient operation of the image signal transmitting apparatus, the above-mentioned Internet Protocol addresses can be programmed into the image signal transmitting apparatus in advance. The user only needs a simple number keypad if he or she needs to select the addresses of appropriate image signal receiving centers.

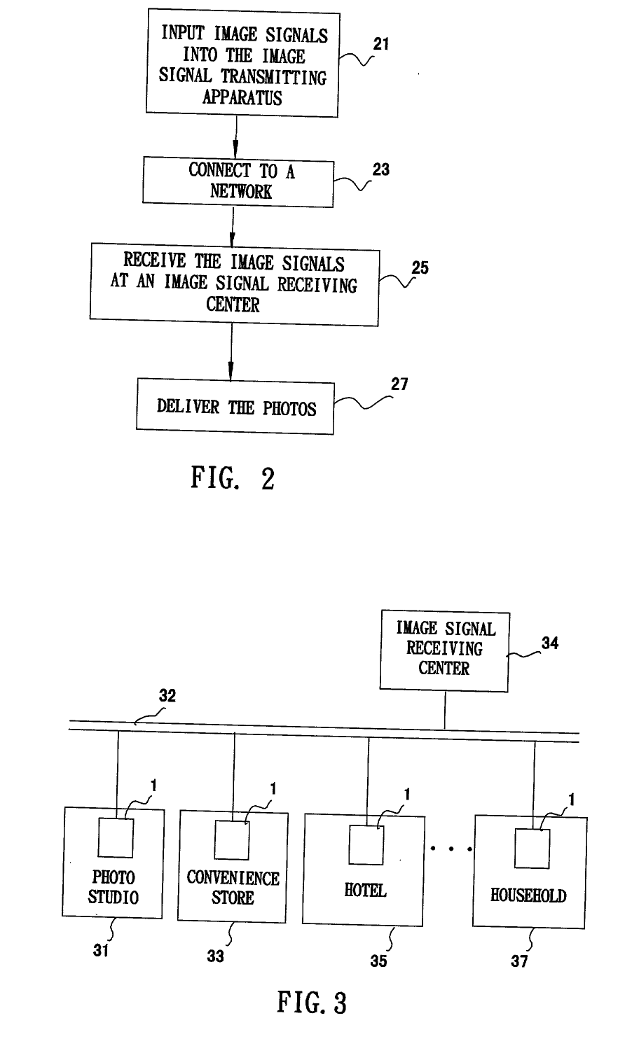

Referring to FIG. 3, a block diagram of the image signal transmitting method in FIG. 2 using network transmission. The above-mentioned image signal transmitting apparatus 1 is installed in an ordinary photo studio 31, a convenience store 33, a hotel 35, or a household 37. After having taken photos with the digital still camera 11, scanned the patterns using the scanner 13, or stored the image data in a CD-ROM, hard disk, or floppy disk, the user can go to the nearby photo studio 31, convenience store 33, hotel 35 or household 37 to link with the image signal transmitting apparatus 1. The user can further get connected to a network using the Internet or a LAN and have the image signals transmitted to the image signal receiving center 34 equipped with the ongoing image processing equipment for central image processing. Photos can be produced through optical projection and be sent to users by mail or courier. Of course, the network transmission can be changed to the WCS transmission without deviating from the spirit and the scope of protection of the invention.

The above-mentioned embodiment is an example of the invention's applications in the techniques of photo developing. However, the image signal transmitting method of the invention can also be applied to other commercial activities. For instance, pictures or patterns like family life photos taken with a digital still camera, or received via an e-mail are representative of a specific period of time. The owner can have them developed into photos, or further have them printed on articles such as caps, mugs, flags, cakes, or clothes; or even make a removable watch board of them. These commercial activities can be readily realized by using the method disclosed according to the invention. Image signals, inputted using the image signal transmitting apparatuses installed in different places, are transmitted to image signal receiving centers via networks or wireless communication systems in which the image signals are centrally processed and corresponding images are then printed on the articles such as caps, mugs, or clothes. In this way, the user can receive pleasant works without spending too much time.

The feature of the invention is to transmit image signals by means of a simple structured image signal transmitting apparatus instead of a general-purpose and expensive personal computer. Furthermore, the user can go to one of the nearby convenience stores, photo studios, hotels or households, which have been equipped with an image signal transmitting apparatus, and send the image signals to be processed to image signal receiving centers for central processing. It is convenient and cost efficient as well.

According to the invention, a simple and convenient image signal transmitting apparatus is to transmit image signals of color images taken with a digital still camera or beautiful pictures scanned by a scanner. High quality digital images can then developed into photos at a lower cost. In addition, personal styles are manifested by having pictures or patterns, which are widely available in everyday life printed on daily necessities such as caps, cups or clothes. It has the advantages of being simple, convenient and economic at the same time.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image signal transmitting apparatus for transmitting image signals stored in an image acquiring system or a storage system to an image signal receiving center for processing the image signals, the image signal transmitting apparatus comprising:
a function selection panel, comprising a multiple keypad, for the entering of transmission signals;
a receiving unit, comprising a transmission interface, wherein the receiving unit receives the image signals stored in the image acquiring system or storage system through the transmission interface;
a controller for receiving the image signals received through the transmission interface and the transmission signals, and for controlling the sending of the image signals; and
a transmitting unit coupled to the controller, for sending the image signals to the image receiving center in a remote location according to the transmission signals.

2. The image signal transmitting apparatus of claim 1, wherein the multiple keypad can be used to input at least numbers 0 to 9 and letters A to Z.

3. The image signal transmitting apparatus of claim 1, wherein the transmitting unit is connected to a network system to transmit the image signals.

4. The image signal transmitting apparatus of claim 3, wherein the transmission signals are associated with a user's Internet Protocol (IP) address and an address of a website by which the image signals are to be sent to the image signal receiving center.

5. The image signal transmitting apparatus of claim 1, wherein the transmitting unit is connected to a wireless communication system for the transmission of the image signals.

6. The image signal transmitting apparatus of claim 5, wherein the transmission signals are associated with communication numbers by which the image signals are to be sent to the image signal receiving center.

7. The image signal transmitting apparatus of claim 5, wherein the WCS is the third generation mobile communication system.

8. The image signal transmitting apparatus of claim 1, wherein the controller is a microprocessor.

9. The image signal transmitting apparatus of claim 1, wherein the transmission interface is a Universal Serial Bus (UBS) interface.

10. The image signal transmitting apparatus of claim 1, wherein the transmission interface is used for accessing a Personal Computer Memory Card International Association (PCMCIA) card which is coupled with the transmission interface.

11. The image signal transmitting apparatus of claim 1, wherein the transmission interface is an Integrated Device Electronics Controller (IDE) interface.

12. The image signal transmitting apparatus of claim 1, wherein the image signal transmitting apparatus further comprises:
a display panel for displaying the contents inputted through the multiple keypad and a status of image signal transmission.

13. The image signal transmitting apparatus of claim 1, wherein the image signal receiving center is used for processing the image signals so as to produce photos by developing the images using optical projection techniques.

14. The image signal transmitting apparatus of claim 1, wherein the image signal receiving center is used for processing the image signals so as to print photos on an article according to the image signals.
